(19) United States
(12) Patent Application Publication
(10) Pub. No.: US 2013/0347075 A1
(43) Pub. Date: Dec. 26, 2013

(54) METHOD AND APPARATUS FOR SECURE CONSOLIDATION OF CLOUD SERVICES

(71) Applicants: Siva G. Narendra, Portland, OR (US); Prabhakar Tadepalli, Bangalore (IN); Todd Raymond Nuzum, Omaha, NE (US)

(72) Inventors: Siva G. Narendra, Portland, OR (US); Prabhakar Tadepalli, Bangalore (IN); Todd Raymond Nuzum, Omaha, NE (US)

(73) Assignee: TYFONE, INC., Portland, OR (US)

(21) Appl. No.: 13/531,342

(22) Filed: Jun. 22, 2012

(51) Int. Cl. G06F 21/20; G06F 21/00

(52) U.S. Cl. 726/4; 726/6

(57) ABSTRACT

Cloud services are provided to mobile devices. Applications access cloud services through a consolidator that consolidates the services. The mobile device may include a secure element and secure memory to which the consolidator may authenticate. Authenticated consolidators can control the lifecycle of applications and data in secure memory. Secure elements and secure memory may be embedded or integrated in the mobile device in non-removable add-on slots, or may be in a removable or remote add-on device.

### FIELD

The present invention relates generally to mobile devices, and more specifically to consolidation of services provided to mobile devices.

### BACKGROUND

FIG. 1 shows a prior art mobile device 100 that includes applications and data stored in memory. Applications with similar names denote applications with similar functionality. For example, APP A1 and APP A2 may provide similar, or even identical, functionality.

FIG. 2 shows a second prior art mobile device 200. Mobile device 200 includes one application in common with mobile device 100 (APP C), and one application that is unique to mobile device 200 (APP B2).

FIG. 3 shows mobile device 100 accessing cloud services through a central point 310. Services are shown in clouds to represent that the services are accessed on a network such as a private network or the Internet. Example cloud services may include, but are not limited to, a drugstore photo printing service, an online file storage service, or an email service.

Central point 310 may be a server in a corporate network that controls access between mobile device 100 and cloud services. When mobile device 100 accesses cloud services, mobile device 100 first communicates with central point 310, shown at (1). If central point 310 does not block access, then central point 310 forwards information to the cloud service (2), receives a response from the cloud service (3), and then provides the response (or a filtered version of the response) to mobile device 100 (4).

A cloud service may deny access when it realizes it is being accessed through a central point. For example, when a cloud service determines that multiple users are accessing services through an identical internet protocol (IP) address corresponding to a central point, the cloud service may deny service.

### BRIEF DESCRIPTION OF THE DRAWINGS

FIGS. 1 and 2 show prior art mobile devices with applications that access services;

FIG. 3 shows a prior art mobile device accessing cloud services through a central point;

FIG. 4 shows a mobile device accessing consolidated cloud services in accordance with various embodiments of the invention;

FIGS. 5A and 5B show a mobile device accessing consolidated banking services in accordance with various embodiments of the present invention;

FIG. 6 shows a mobile device enrolling in consolidated banking services in accordance with various embodiments of the invention;

FIGS. 7-9 show mobile device screenshots for enrolling a user in consolidated banking services in accordance with various embodiments of the present invention;

FIG. 10 shows a flowchart of methods in accordance with various embodiments of the present invention;

FIG. 11 shows a block diagram of a mobile device in accordance with various embodiments of the present invention;

FIGS. 12 and 13 show consolidated mobile devices with secure elements in accordance with various embodiments of the present invention;

FIG. 14 shows a consolidated mobile device accessing both consolidated and non-consolidated cloud services in accordance with various embodiments of the present invention;

FIG. 15 shows a consolidated mobile device with multiple secure elements in accordance with various embodiments of the present invention;

FIG. 16 shows a block diagram of a mobile device with a secure element in accordance with various embodiments of the present invention;

FIG. 17 shows various entities authenticating to a secure element in accordance with various embodiments of the present invention;

FIG. 18 shows a secure element and a memory device that interface to a mobile device through a controller in accordance with various embodiments of the present invention;

FIGS. 19 and 20 show alternate embodiments of secure elements, memory controllers, and memory devices;

FIG. 21 shows a mobile device with a memory card that includes a secure element in accordance with various embodiments of the present invention;

FIG. 22 shows a mobile device with a universal serial bus (USB) device that includes a secure element in accordance with various embodiments of the present invention;

FIG. 23 shows a mobile device with a secure element on a subscriber identity module (SIM) card in accordance with various embodiments of the present invention;

FIG. 24 shows a mobile device with a contactless interface and a contactless device that includes a secure element in accordance with various embodiments of the present invention; and

FIG. 25 shows a mobile device with a dock connector and a device compatible with the dock connector that includes a secure element in accordance with various embodiments of the present invention.

### DESCRIPTION OF EMBODIMENTS

In the following detailed description, reference is made to the accompanying drawings that show, by way of illustration, various embodiments of an invention. These embodiments are described in sufficient detail to enable those skilled in the art to practice the invention. It is to be understood that the various embodiments of the invention, although different, are not necessarily mutually exclusive. For example, a particular feature, structure, or characteristic described in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

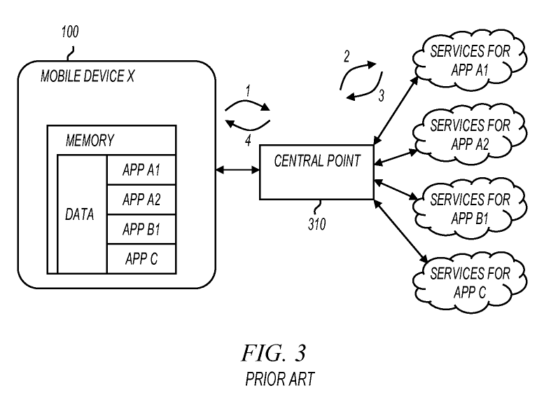

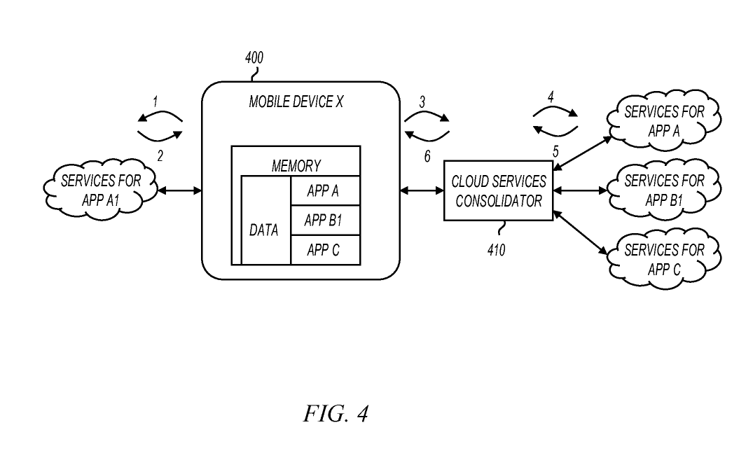

FIG. 4 shows a mobile device accessing consolidated cloud services in accordance with various embodiments of the invention. Mobile device 400 corresponds to mobile device 100 (FIG. 3) with applications APP A1 and APP A2 replaced with application APP A. Cloud services for APP Al and cloud services for APP A2 are similarly consolidated into cloud services for APP A. The operational combination of APP A, cloud services consolidator 410, and cloud services for APP A facilitate this consolidation. Various consolidation embodiments are described more fully below.

In some embodiments, APP A1 and APP A2 may provide similar functionality to the point where one of the cloud services corresponding thereto may be able to provide all services. In one example, APP A1 and cloud services for APP A1 may correspond to a free (or ad supported) online storage site, whereas APP A2 and cloud services for APP A2 may correspond to a corporate online storage site. When consolidated, APP A corresponds to the corporate online storage site, and all requests for service from the free online storage site are routed to the cloud services for APP A, which is the corporate online storage site. In this example, services provided by two online storage sites have been consolidated into one.

In some embodiments, cloud services consolidator 410 may be a corporate central point that includes consolidation functionality. In other embodiments, cloud services consolidator 410 may be a server hosted to provide specific consolidation functionality (e.g. consolidation of online banking services). Examples of online banking consolidation are provided below.

Although APP A and cloud services for APP A are described above as providing all services previously provided by APP A1 and APP A2 (and their corresponding cloud services), this is not a limitation of the present invention. For example, services provided by APP A and cloud services for APP A may be the same, more, or less than the sum of services provided by APPS A1 and A2 (and their corresponding cloud services). In some embodiments, APP A provides at least a subset of the services provided by APP A1.

In some embodiments, consolidation occurs after validating a user's credentials for a service that is to be consolidated. For example, as shown in FIG. 4, mobile device 400 (under the control of APP A) may provide user credentials to cloud services for APP A1, shown at (1). The results are then provided back to mobile device 400 at (2). All or a portion of the results are provided to cloud services consolidator 410 at (3), and cloud services consolidator 410 may then determine whether the validation of user credentials was a success. If a success, then cloud services consolidator 410 informs cloud services for APP A at (4), which then provides consolidated services at (5). Cloud services consolidator 410 then provides the consolidated services to mobile device 400 at (6).

In the example of FIG. 4, APPS A1 and A2 have been consolidated, but APPS B1 and C have not. Further, mobile device 400 may have other applications that access cloud services without passing through cloud services consolidator 410.

Mobile device 400 may be any mobile device capable of accessing services as described herein. Examples include, but are not limited to, mobile phones, laptop computers, tablet computers, personal digital assistants, and the like. Further, as used herein, the terms “APP” and “application” refer to any component capable of accessing cloud services. For example, “APP” and/or “application” may refer to a downloaded application, an installed application, or a browser accessing a particular cloud service (e.g. online file storage).

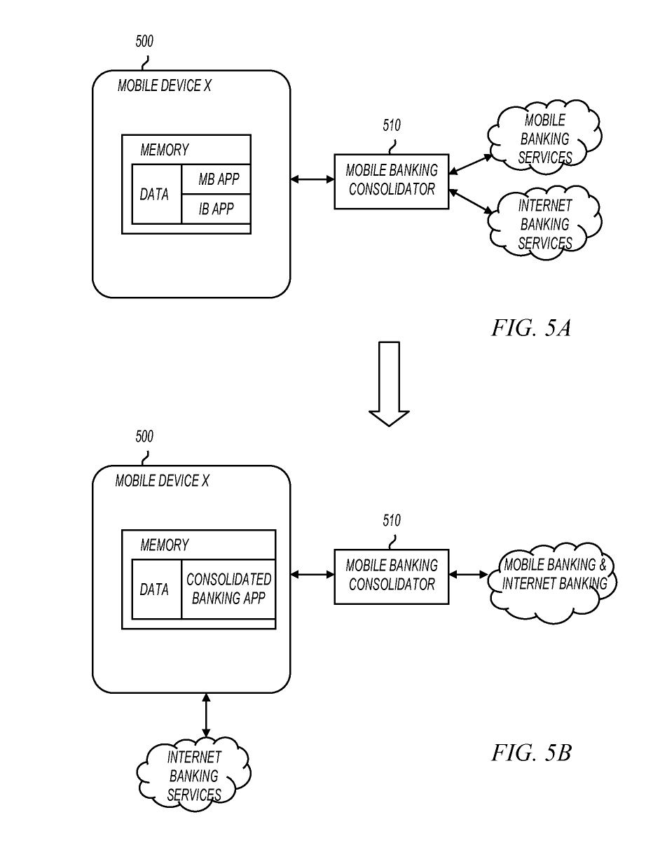

FIGS. 5A and 5B show a mobile device accessing consolidated banking services in accordance with various embodiments of the present invention. FIGS. 5A and 5B depict banking services as a specific embodiment of cloud service consolidation, although the various embodiments of the present invention are not so limited. Any type of cloud service may be consolidated without departing from the scope of the present invention.

Mobile device 500 is shown in FIG. 5A including two applications: a mobile banking application (MB APP), and an internet banking application (IB APP). Both banking apps access cloud services through mobile banking consolidator 510. In some embodiments, mobile banking consolidator 510 is a server hosted by a mobile banking provider.

FIG. 5B shows mobile device 500 with a single consolidated banking application that replaces the mobile banking application and the internet banking application. Likewise, mobile banking consolidator 510 provides both mobile banking and internet banking services from the cloud. The terminology used to describe the consolidator (e.g., “mobile banking consolidator”) is not meant to be limiting terminology. For example, mobile banking consolidator 510 may instead be referred to as an “internet banking consolidator,” a “banking consolidator,” or a “consolidator,” or even as a “central point.” In general, mobile banking consolidator 510 may be any consolidator or central point providing consolidated services to a mobile device.

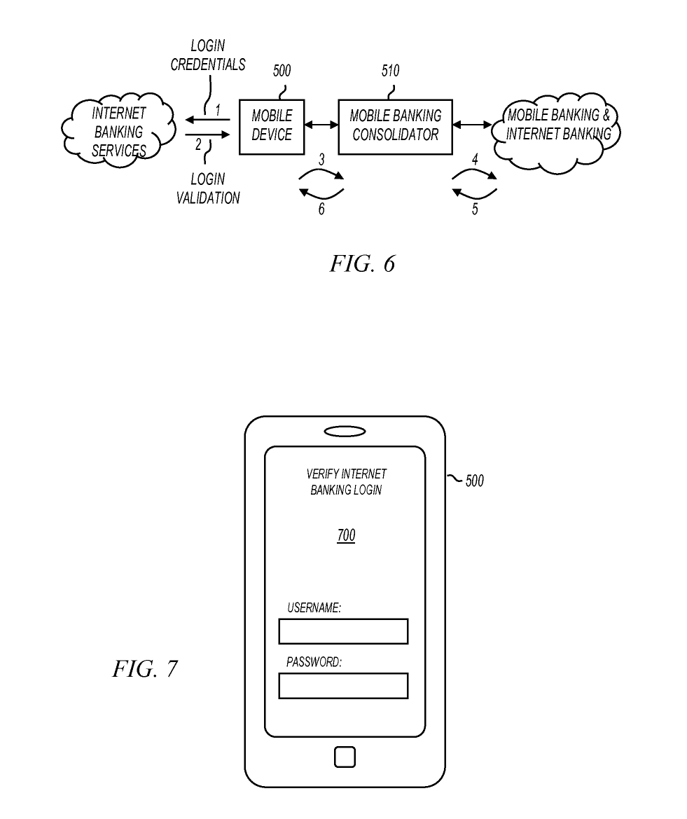

FIG. 6 shows a mobile device enrolling in consolidated banking services in accordance with various embodiments of the invention. In some embodiments, consolidation of banking services occurs after validating a user's credentials for internet banking For example, as shown in FIG. 6, mobile device 500 (under the control of the consolidated mobile banking application) may provide user login credentials to internet banking services, shown at (1). The results are then provided back to mobile device 500 at (2). All or a portion of the results are provided to mobile banking consolidator 510 at (3), and mobile banking consolidator 410 may then determine whether the validation of user login credentials was a success. If a success, then mobile banking consolidator 510 informs cloud services for mobile banking and internet banking at (4), which then provides consolidated services at (5). Mobile banking consolidator 510 then provides the consolidated services to mobile device 500 at (6).

FIGS. 7-9 show screenshots on mobile device 500 for enrolling a user in consolidated banking services in accordance with various embodiments of the present invention. Screenshot 700 (FIG. 7) shows an example screen that the consolidated mobile banking application may display for a user to enter internet banking login credentials. The login credentials are shown as a username/password, but any type or amount of credentials may be utilized. Additionally, further user authentication factors maybe collected to verify the user's identity. For example, screenshot 800 (FIG. 8) also collects an account number and the last four digits of the user's social security number.

After collecting user login credentials for internet banking, they are sent to the internet banking services for validation (shown at 1, FIG. 6). The internet banking services respond with a validation response (shown at 2, FIG. 6). This response includes content that either validates the login credentials, or denies access to internet banking because the credentials are invalid.

Content determines validity of login credentials. For example, the mobile banking consolidator may expect a certain webpage to be returned if the validation is successful. The content of the response from the internet banking services is sent to mobile banking consolidator for verification. In some embodiments, further user authentication data is also sent. For example, in embodiments represented by FIG. 8, an account number and/or the last four digits of the user's social security number may be forwarded as user authentication data to mobile banking consolidator 510.

If mobile banking consolidator 510 determines that the internet banking login credentials were valid (and possibly verifies the further user authentication factors), then a message is sent back to the consolidated mobile banking application to create a new consolidated banking login for the user.

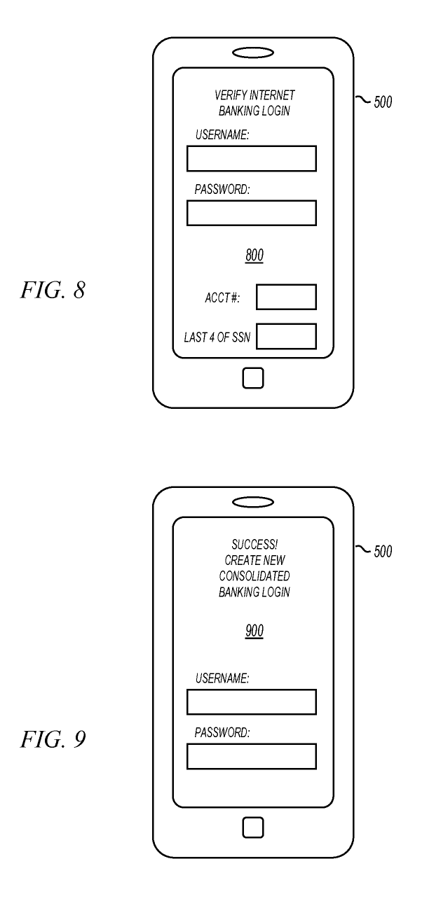

FIG. 9 shows an example screenshot 900 for this purpose. The user enters a new username/password for the consolidated banking services, and thereafter, both internet banking and mobile banking may be accessed with one login.

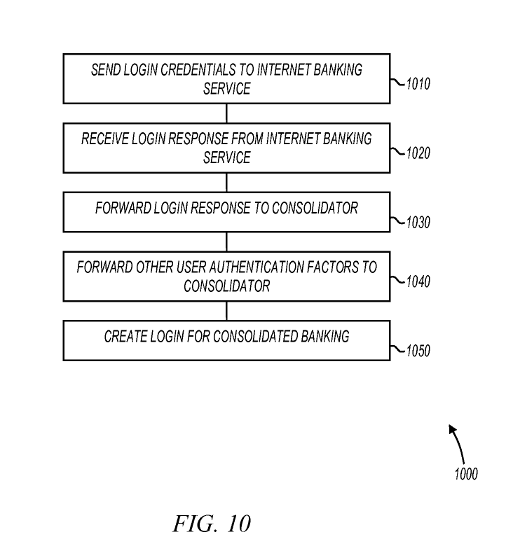

FIG. 10 shows a flowchart of methods in accordance with various embodiments of the present invention. In some embodiments, method 1000 may be performed by an application within a mobile device such as the consolidated banking application (FIG. 5B). In other embodiments, method 1000 may be performed by a mobile device that is performing actions in accordance with consolidated banking For example, mobile device 500 (FIGS. 5A, 5B, 6) may perform the actions of method 1000. Method 1000 is not limited by the type of system or entity that performs the method. The various actions in method 1000 may be performed in the order presented, in a different order, or simultaneously. Further, in some embodiments, some actions listed in FIG. 10 are omitted from method 1000.

Method 1000 begins at 1010 in which login credentials are sent to an internet banking service. In some embodiments, this corresponds to mobile device 500 sending login credentials, such as username/password to an internet banking service as shown at (1, FIG. 6).

At 1020, a login response is received from the internet banking service. This corresponds to (2, FIG. 6). At 1030, the login response is forwarded to the consolidator. This corresponds to (3, FIG. 6). At 1040, other user authentication factors are forwarded to the consolidator. This corresponds to forwarding the additional user authentication factors collected as shown in FIG. 8. And at 1050, a login is created for consolidated banking This corresponds to collecting login credentials as shown in FIG. 9.

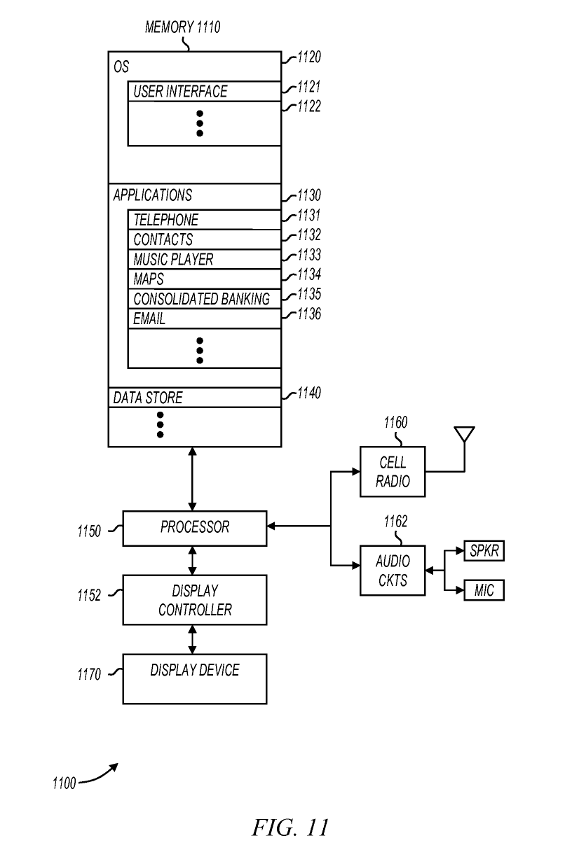

FIG. 11 shows a block diagram of a mobile device in accordance with various embodiments of the present invention. Mobile device 1100 includes processor 1150, memory 1110, display controller 1152, display device 1170, cellular radio 1160, and audio circuits 1162. Mobile device 1100 may be any type of mobile device that includes the components shown. For example, in some embodiments, mobile device 1100 may be a cell phone, a smartphone, a tablet computer, a laptop computer, or the like.

Processor 1150 may be any type of processor capable of executing instructions store in memory 1110 and capable of interfacing with the various components shown in FIG. 11. For example, processor 1150 may be a microprocessor, a digital signal processor, an application specific processor, or the like. In some embodiments, processor 1150 is a component within a larger integrated circuit such as a system on chip (SOC) application specific integrated circuit (ASIC).

Display controller 1152 provides an interface between processor 1150 and display device 1170. In some embodiments, display controller 1152 is integrated within processor 1150, and in other embodiments, display controller 1152 is integrated within display device 1170.

In some embodiments, display device 1170 is a display device that includes a touch sensitive surface, sensor, or set of sensors that accept input from a user. For example, touch sensitive display device 1170 may detect when and where an object touches the screen, and may also detect movement of an object across the screen.

Cellular radio 1160 may be any type of radio that can communication within a cellular network. Examples include, but are not limited to, radios that communicate using orthogonal frequency division multiplexing (OFDM), code division multiple access (CDMA), time division multiple access (TDMA), and the like. Cellular radio 1160 may operate at any frequency or combination of frequencies without departing from the scope of the present invention. In some embodiments, cellular radio 1160 is omitted. In still further embodiments, cellular radio 1160 is replaced by, or used in conjunction with, other communications devices, such as WiFi radio or WiMax radio.

Audio circuits 1162 provide an interface between processor 1150 and audio devices such as a speaker and microphone.

Mobile device 1100 may include many other circuits and services that are not specifically shown in FIG. 11. For example, in some embodiments, mobile device 1100 may include a global positioning system (GPS) radio, a Bluetooth radio, haptic feedback devices, and the like. Any number and/or type of circuits and services may be included within mobile device 1100 without departing from the scope of the present invention.

Memory 1110 may include any type of memory device. For example, memory 1110 may include volatile memory such as static random access memory (SRAM), or nonvolatile memory such as FLASH memory. Memory 1110 is encoded with (or has stored therein) one or more software modules (or sets of instructions), that when accessed by processor 1150, result in processor 1150 performing various functions. In some embodiments, the software modules stored in memory 1110 may include an operating system (OS) 1120 and applications 1130. Applications 1130 may include any number or type of applications. Examples provided in FIG. 11 include a telephone application 1131, a contacts application 1132, a music player application 1133, a maps application 1134, a consolidated banking application 1135, and an email application 1136. Memory 1110 may also include any amount of space dedicated to data storage 1140.

Operating system 1120 may be a mobile device operating system such as an operating system to control a mobile phone, smartphone, tablet computer, laptop computer, or the like. As shown in FIG. 11, operating system 1120 includes user interface component 1121. Operating system 1120 may include many other components without departing from the scope of the present invention.

Telephone application 1131 may be an application that controls a cell phone radio. Contacts application 1132 includes software that organizes contact information. Contacts application 1132 may communicate with telephone application 1131 to facilitate phone calls to contacts. Music player application 1133 may be a software application that plays music files that are stored in data store 1140. Maps application 1134 may be a software application that provides access to map data.

Consolidated banking application 1135 may be a software application that communicates with a mobile banking consolidator such as mobile banking consolidator 510 (FIGS. 5A, 5B) to allow banking functions such as balance inquiries, funds transfers, bill payment and the like. Consolidated banking application 1135 may be a downloaded “thick” application, or may be a “thin” application that uses internet browser functionality. Other application examples include applications that store an identity such as a passport or a building access identity.

Each of the above-identified applications correspond to a set of instructions (or “program”) for performing one or more functions described above. These applications (sets of instructions) need not be implemented as separate software programs, procedures or modules, and thus various subsets of these applications may be combined or otherwise re-arranged in various embodiments. For example, telephone application 1131 may be combined with contacts application 1132. Furthermore, memory 1110 may store additional applications (e.g., video players, camera applications, etc.) and data structures not described above.

It should be noted that device 1100 is presented as an example of a mobile device, and that device 1100 may have more or fewer components than shown, may combine two or more components, or may have a different configuration or arrangement of components. For example, mobile device 1100 may include many more components such as sensors (optical, touch, proximity etc.), or any other components suitable for use in a mobile device.

Memory 1110 represents a computer-readable medium capable of storing instructions, that when accessed by processor 1150, result in the processor performing as described herein. For example, when processor 1150 accesses instructions within consolidated banking application 1135, processor 1150 may perform the actions listed in method 1000 (FIG. 10).

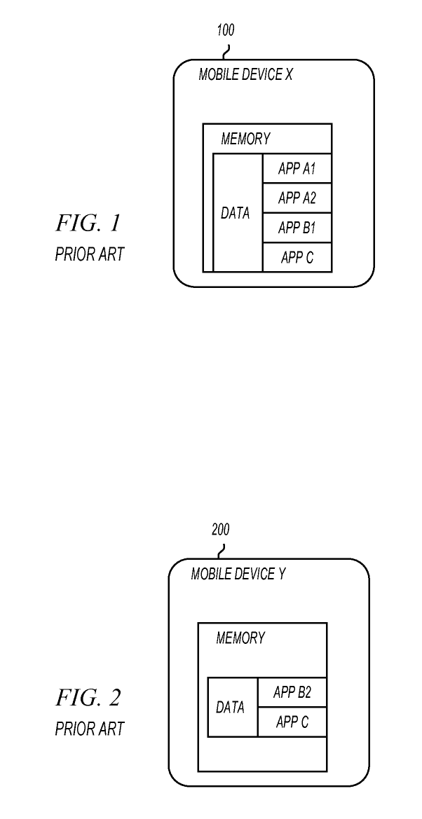

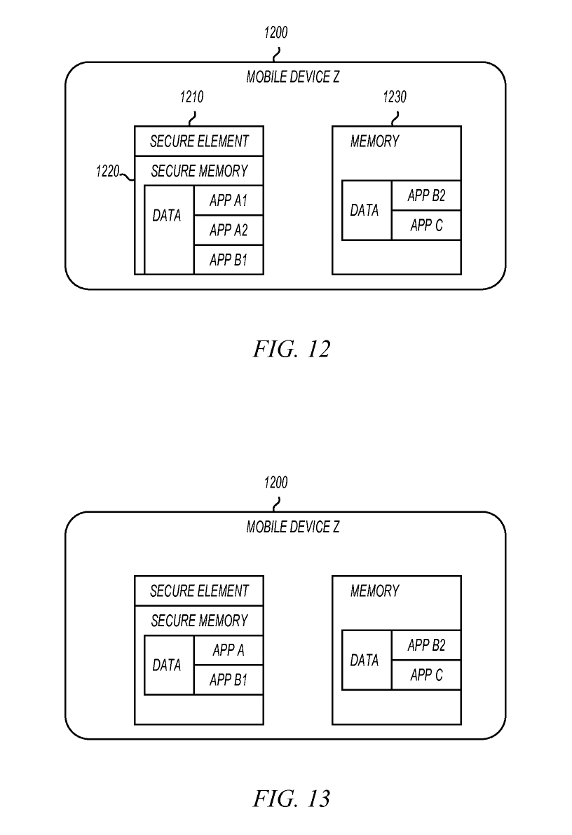

FIGS. 12 and 13 show consolidated mobile devices with secure elements in accordance with various embodiments of the present invention. Mobile device 1200 corresponds to the combination of mobile devices 100 (FIG. 1) and 200 (FIG. 2). Mobile device 1200 includes memory 1230 that stores applications B2 and C. Mobile device 1200 also includes secure memory 1210 that stores applications A1, A2, and B1. Mobile device 1200 also includes secure element 1210.

In some embodiments, secure element 1210 is used to control access to the contents of secure memory 1220. For example, access to secure memory 1220 may only be granted after a user or cloud service is authorized by secure element 1210. Accordingly, the contents of secure memory 1220 (data and/or applications) may be added, modified, or deleted only after access has been granted. In some embodiments, access can be granted to a user, which can then add, modify, or delete the contents of secure memory 1220. In other embodiments, access may be granted to a consolidator or a cloud service, which can then add, modify, or delete the contents of secure memory 1220.

The addition of secure element 1210 to the mobile device allows the consolidation of the two mobile devices 100 and 200 in part because secure element 1210 provides for separate control of two separate memory spaces. The addition of secure element 1210 also protects the content from unwanted modification of the secure memory space and also decouples modification of data belonging to similar applications independent of each other. For example if APP B2 is a photo application whose data belongs to a corporation and APP B1 is a photo application whose data is personal in nature, a corporation deleting all information of APP B2 such as photographs when an employee leaves the company will not resulting in deleting of personal photographs.

In the example of FIG. 12, applications APP A1 and APP A2 are resident in secure memory 1220. APPS A1 and A2 represent applications that can be consolidated further as described above with reference to previous figures. Applications APP B2 and APP C are resident in memory 1230, which is not controlled by a secure element. In some embodiments, these applications may be added, modified, or deleted without any authorization required by a secure element.

Memory 1220 and 1230 may be any kind of memory device as described above with reference to FIG. 11. Further, memory 1220 and 1230 may be two partitions of one physical memory device.

In some embodiments, secure element 1210 is a smartcard compatible secure element commonly found in credit card applications and/or security applications. In some embodiments, secure element 1210 is a secure element included within a smartcard controller. Examples of smartcard controllers that include a secure element are the “SmartMX” controllers sold by NXP Semiconductors N.V. of Eindhoven, The Netherlands. In some embodiments, the secure element has an ISO/IEC 7816 compatible interface that communicates with other components within mobile device 1200. Further, in some embodiments, the secure element is part of a smartcard controller that includes a near field communications (NFC) radio that has an ISO/IEC 14443 compatible contactless interface.

Secure element 1210 may include internal memory. In some embodiments, secure memory 1220 is not memory internal to secure element 1210, but is instead memory that is outside secure element 1210.

Secure element 1210 may be in any location, including within mobile device 1200, on a card or a chip in a physical add-on slot of mobile device, or in communications with mobile device over a contactless interface. Cards in add-on slots may or may not be removable. For example, a memory card may be user accessible and removable, or may be embedded deep within the mobile device to provide system memory, and non-removable. Chips in an add-on slot of the printed circuit board may or may not be removable. For example, a chip may be soldered onto a physical slot added on the printed circuit board and therefore may not be removable or the chip could be in a removable slot. In some embodiments, secure element 1210 and secure memory 1220 may be combined together through packaging, bonding, integrating, or other physical proximity processes. Smartcard secure elements and their various possible locations are described more fully below.

FIG. 13 shows the same consolidated mobile device 1200 as in FIG. 12 with the exception that APPS Al and A2 have been consolidated into APP A. The various mechanisms to accomplish this consolidation of services are described above with reference to FIGS. 4-10.

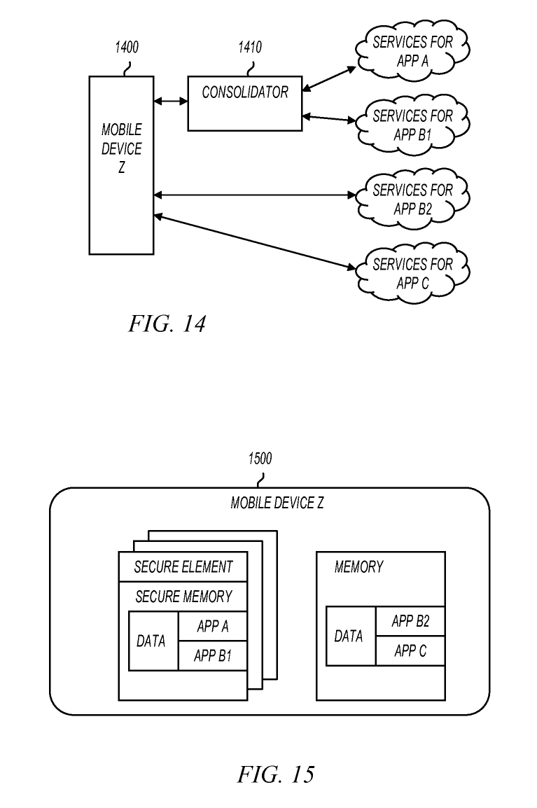

FIG. 14 shows a consolidated mobile device accessing both consolidated and non-consolidated cloud services in accordance with various embodiments of the present invention. Consolidated mobile device 1400 corresponds to mobile device 1200 shown in FIG. 13 with consolidated cloud services. For example, consolidated mobile device 1400 includes a secure element that controls access to a secure memory that includes APPS A and B1. Further, consolidated mobile device 1400 includes a non-access controlled memory that includes APPS B2 and C.

In some embodiments, consolidated mobile device 1400 grants consolidator 1410 access to secure memory after authorization. In these embodiments, consolidator 1410 may have control over the addition, deletion, and modification of secure memory contents. For example, in some embodiments, consolidator 1410 may be a corporate central point that controls access to corporate cloud services for APPS A and B1. If mobile device 1400 is lost or stolen, consolidator 1410 may be able to remotely wipe the secure memory within mobile device 1400 with or without affecting the memory that is not secure.

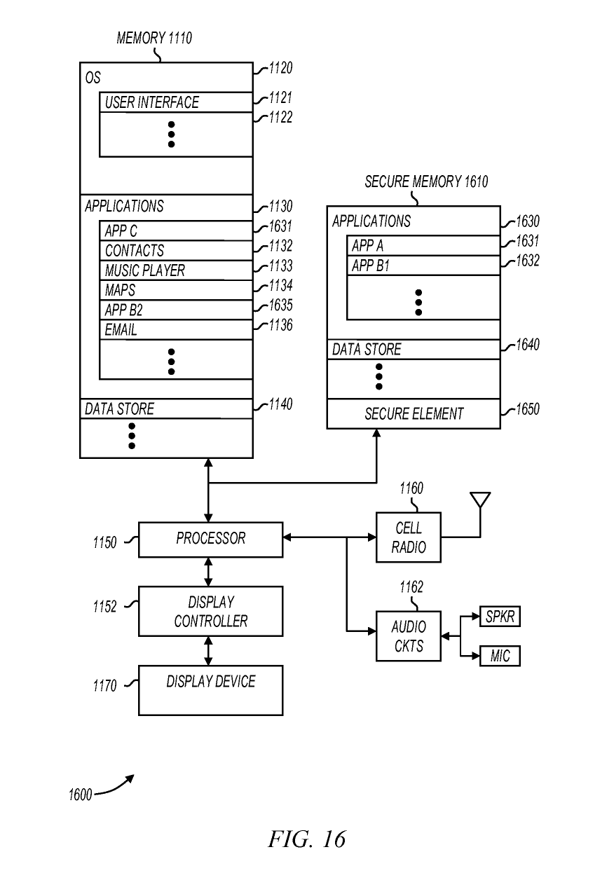

FIG. 15 shows a consolidated mobile device with multiple secure elements in accordance with various embodiments of the present invention. Mobile device 1500 includes multiple secure elements controlling access to multiple secure memory devices or multiple memory partitions. In some embodiments, each secure element supports a single consolidator such that different secure memories can be accessed by different consolidators. The multiple secure elements maybe physical secure elements or logical secure elements.

FIG. 16 shows a block diagram of a mobile device with a secure element in accordance with various embodiments of the present invention. Mobile device 1600 corresponds to any of the mobile devices described herein that includes a secure element (e.g., mobile devices 1200, 1400, 1500).

Mobile device 1600 includes memory 1110, processor 1150, display controller 1152, display device 1170, cellular radio 1160, and audio circuits 1162, all of which are described above with reference to FIG. 11. Mobile device 1600 also includes secure element 1650 and secure memory 1610. Secure memory 1610 is secured by secure element 1650. In some embodiments, secure memory 1610 is accessed by a consolidator only after authorization by secure element 1650.

As shown in FIG. 16, secure memory 1610 includes applications 1630 and data store 1640. Applications 1630 include APP A 1631 and APP B1 1632. APP A is a consolidated application that provides consolidated services as described above with respect to previous figures.

Memory 1110 includes applications APP C at 1631 and APP B2 at 1635. These applications correspond to the applications of the same name shown in FIGS. 12 and 13. In some embodiments, APP C corresponds to an application that does not need to secured. For example, APP C may a telephone application that exists in most devices (e.g., mobile device 100, 200).

In some embodiments, memory 1110 and memory 1610 are part of one physical memory device that is partitioned by secure element 1650. In other embodiments, memory 1110 and memory 1610 are separate physical memory devices.

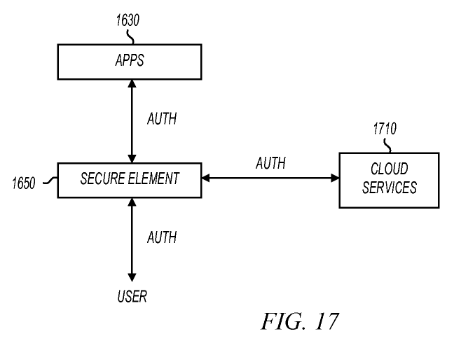

FIG. 17 shows various entities authenticating to a secure element in accordance with various embodiments of the present invention. For example, a user of the mobile device may authenticate to secure element 1650, applications 1630 may authenticate to secure element 1650, and cloud services 1710 may authenticate to secure element 1650. When a particular entity is authenticated to secure element 1650, then authorization is granted to access secure memory, and applications and/or data may be added, modified, or deleted by the authorized entity. In some embodiments, mutual authentication between the various entities may be required. For example, an application may be authenticated to the secure element, and the secure element may be authenticated to the application. Also, the cloud service may be authenticated to the secure element and the secure element may be authenticated to the cloud service. In some embodiments, one or more of the entities may be authenticated into the secure element or authenticated mutually into the secure element or any combination thereof.

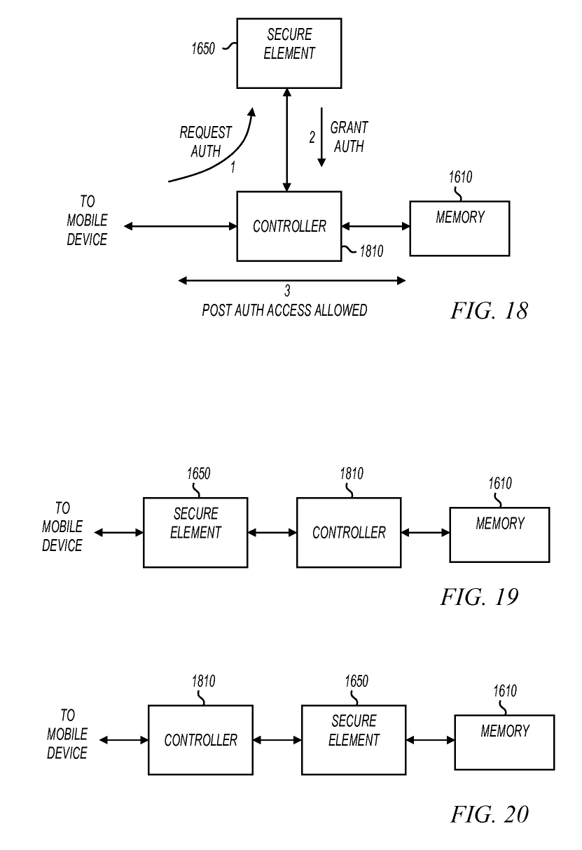

FIG. 18 shows a secure element and a memory device that interface to a mobile device through a controller in accordance with various embodiments of the present invention. In some embodiments, the elements shown in FIG. 18 are embedded in a mobile device, and in other embodiments, the elements shown in FIG. 18 are in an apparatus such as an integrated circuit chip, combination of integrated circuit chips, a microSD memory card, a universal serial bus (USB) dongle, or a subscriber identity module (SIM) card.

Memory 1610, or a portion thereof, is secured by secure element 1650, and entities requesting access to memory 1610 must first be authorized by secure element 1650. An entity wishing to access memory 1610 first requests authorization (1) by authenticating to secure element 1650. In embodiments represented by FIG. 18, the authorization request is presented to controller 1810, which forwards the request to secure element 1650. Without authorization, controller 1810 blocks access to memory 1610, or to the portion of memory 1610 that is secured.

If the entity requesting authorization is authenticated to secure element 1650, then secure element 1650 provides an indication of an authorization grant back to controller 1810. Controller 1810 then allows post-authorization access (3) to memory 1610.

In some embodiments, a consolidator may authenticate to the secure element in order to control the lifecycle of applications and data in the portion of memory 1610 controlled by the secure element, whereas other memory in the device (e.g., memory 1110, FIG. 16) may be controlled by the user. In these embodiments, if the mobile device is compromised, or if the cloud service determines for some other reason to “wipe” the device, then the portion of the memory controlled by the cloud service may be wiped, and the rest of the user data may be maintained.

FIGS. 19 and 20 show alternate embodiments of secure elements, memory controllers, and memory devices. FIG. 19 shows secure element 1650 communicating with the mobile device and controller 1810. In these embodiments, memory accesses are performed through secure element 1650 after authorization. Without authorization, memory accesses are denied directly by secure element 1650. In embodiments represented by FIG. 19, non-authorized memory access attempts are blocked by either secure element 1650 or controller 1810.

FIG. 20 is similar to FIG. 19 with the exception that secure element 1650 is in the data path between controller 1810 and memory 1610. In embodiments represented by FIG. 20, non-authorized memory access attempts are blocked by either secure element 1650 or controller 1810. In some embodiments, secure element 1650, controller 1810, and memory 1610 or any combination of these components may be integrated or packaged into a single component.

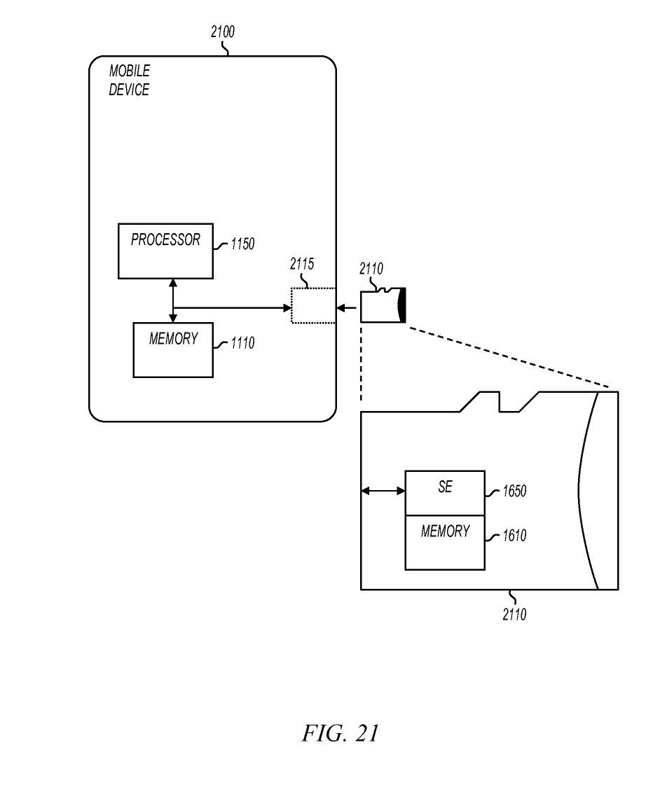

FIG. 21 shows a mobile device with a memory card that includes a secure element in accordance with various embodiments of the present invention. Mobile device 2100 includes add-on slot 2115. Add-on slot 2115 accepts memory card 2110, which is shown as a microSD memory card; however this is not a limitation of the present invention. In some embodiments, microSD memory card 2110 may be added to a non-removable add-on slot. For example, system memory for mobile device 2100 may be provided by memory card 2110, and memory card 2110 may be placed in an add-on slot in such a manner that it is non-removable. In yet another example, the components that constitute a memory card could be directly added to the printed circuit board of the mobile device. Memory card 2110 includes secure element 1650 and memory 1610. In some embodiments, memory card 2110 also includes a controller (e.g., controller 1810, FIG. 18). The combination of mobile device 2100 and memory card 2110 is an example of an electronic system that includes a mobile device and an apparatus that includes a secure element and secure memory to hold applications for accessing consolidated cloud services.

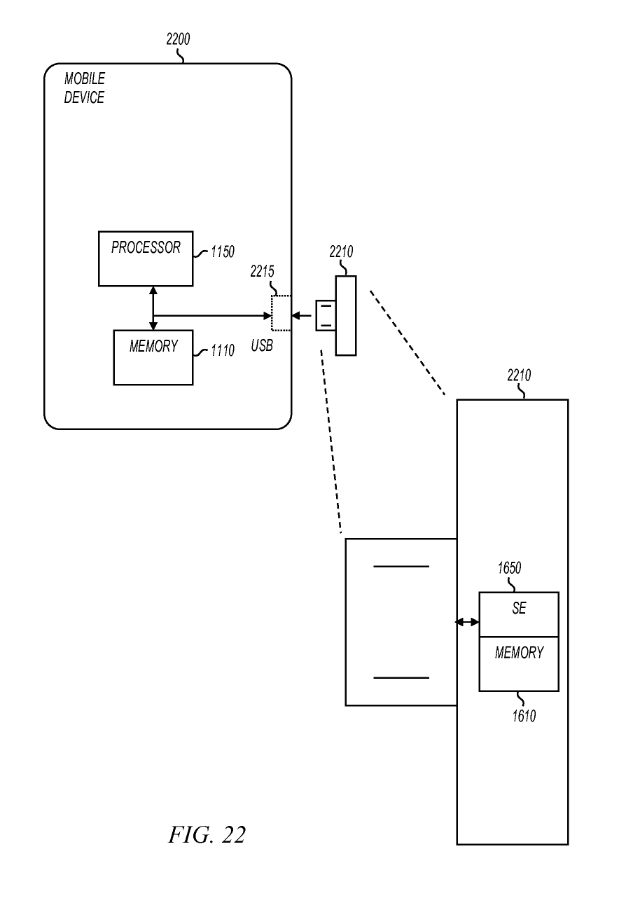

FIG. 22 shows a mobile device with a universal serial bus (USB) device that includes a secure element in accordance with various embodiments of the present invention. Mobile device 2200 includes add-on slot 2215. Add-on slot 2215 is shown as a universal serial bus (USB) port which accepts USB device 2210; however this is not a limitation of the present invention. Add-on slot 2215 may be other than a USB port, and device 2210 may be other than a USB device. USB device 2210 includes secure element 1650 and memory 1610. In some embodiments, USB device 2210 also includes a USB controller (e.g., controller 1810, FIG. 18). The combination of mobile device 2200 and USB device 2210 is an example of an electronic system that includes a mobile device and an apparatus that includes a secure element and secure memory to hold applications for accessing consolidated cloud services. In some embodiments, USB device 2210 may be added to a non-removable add-on slot. In some embodiments, the components that constitute USB device 2210 are directly added to the printed circuit board of the mobile device.

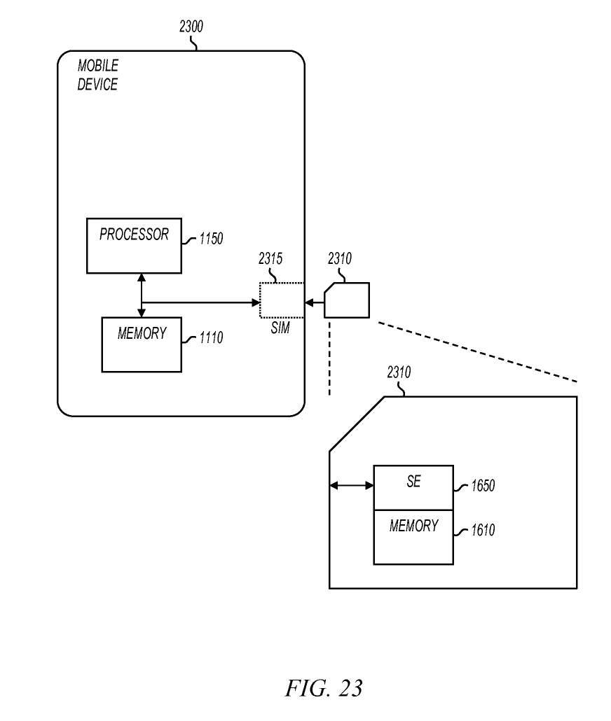

FIG. 23 shows a mobile device with a secure element on a subscriber identity module (SIM) card in accordance with various embodiments of the present invention. Mobile device 2300 includes add-on slot 2315. Add-on slot 2315 accepts subscriber identity module (SIM) card 2310, which in turn includes secure element 1650 and secure memory 1610. In some embodiments, SIM card 2310 also includes a controller (e.g., controller 1810, FIG. 18). The combination of mobile device 2300 and SIM card 2310 is an example of an electronic system that includes a mobile device and an apparatus that includes a secure element and secure memory to hold applications for accessing consolidated cloud services. SIM card 2310 may also include circuits that provide one or more additional services. For example, SIM card 2310 may include other circuits that identify a user of mobile device 2300 to a mobile network operator. In some embodiments, SIM card 2310 is a removable card that is inserted into an add-on slot within mobile device 2300 and that includes many components other than those shown. In some embodiments, SIM card 2310 may be added to a non-removable add-on slot.

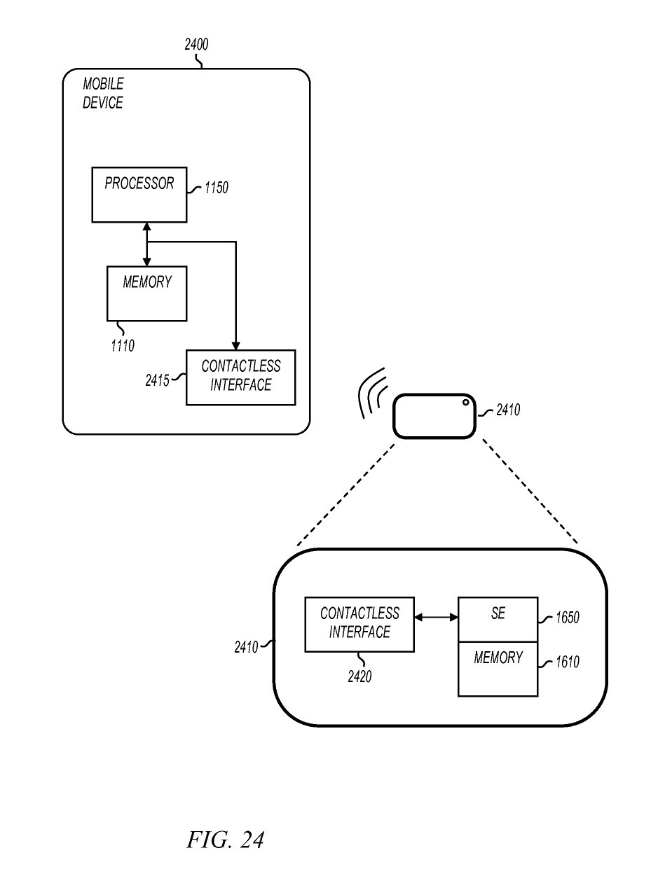

FIG. 24 shows a mobile device with a contactless interface and a contactless device that includes a secure element in accordance with various embodiments of the present invention. Mobile device 2400 includes contactless interface 2415 to communicate with contactless device 2410, which in turn includes contactless interface 2420, secure element 1650 and secure memory 1610. The combination of mobile device 2400 and contactless device 2410 is an example of an electronic system that includes a mobile device and an add-on device that includes a secure element and secure memory to hold applications for accessing consolidated cloud services. Contactless interfaces 2415 and 2410 may communicate using any combination of electric, magnetic, audio, and optical means such as Bluetooth, NFC, broadband radio, Wi-Fi, ultrasound, or infrared communications. Contactless interface 2415 may be active, passive, or partially active or any combination thereof. Similarly, contactless interface 2410 may be active, passive, or partially active or any combination thereof.

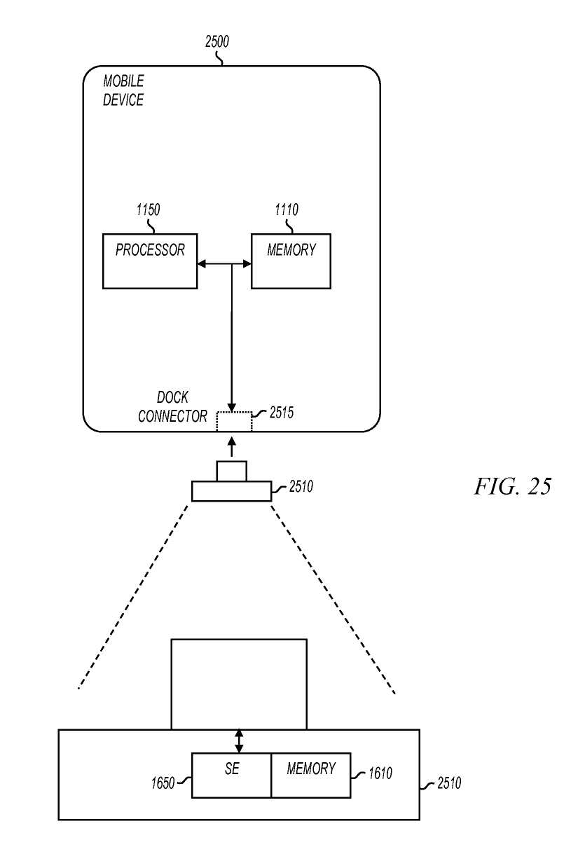

FIG. 25 shows a mobile device with a dock connector and a device compatible with the dock connector that includes a secure element in accordance with various embodiments of the present invention. Mobile device 2500 includes dock connector 2515. Dock connector 2515 represents an add-on slot that may be useful to connect mobile device 2500 to a removable docking device. For example, dock connector may be a 30-pin connector useful to connect mobile devices such as phones and media players to docking devices, or may be a 30-pin connector used to charge a battery within mobile device 2500. Also for example, dock connector 2515 may include more or less than 30 pins. Device 2510 is a device compatible with dock connector 2515. Device 2510 includes secure element 1650 and memory 1610. The combination of mobile device 2500 and device 2510 is an example of an electronic system that includes a mobile device and an apparatus that includes a secure element and secure memory to hold applications for accessing consolidated cloud services.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. A method comprising:
receiving login credentials at a mobile device from a user;
sending the login credentials to a cloud service from the mobile device;
receiving content from the cloud service;
forwarding the content to a consolidator that is configured to provide at least a subset of services provided by the cloud service;
receiving from the consolidator a request to create login credentials for the user; and
prompting the user to create the login credentials for the consolidator.

2. The method of claim 1 further comprising receiving services from the consolidator, wherein the services comprise at least a subset of the services provided by the cloud service.

3. The method of claim 1 further comprising forwarding additional user authentication factors to the consolidator along with the content.

4. The method of claim 1 wherein sending the login credentials to a cloud service comprises sending the login credentials to an internet banking service.

5. The method of claim 4 wherein forwarding the content to a consolidator comprises forwarding the content to a mobile banking consolidator.

6. A system, comprising:
a mobile device configure to communicate with, and receive consolidated cloud services from, a cloud service consolidator, wherein the mobile device comprises:
a processor;
a memory unit coupled to the processor; and
a program for enrolling in consolidated cloud services, wherein the program is stored in the memory unit and configured to be executed by the processor, the program including instructions for:
receiving login credentials from a user;
sending the login credentials to a cloud service;
receiving content from the cloud service;
forwarding the content to the cloud service consolidator;
receiving from the cloud service consolidator a request to create login credentials from the user; and
prompting the user to create the login credentials for the cloud service consolidator.

7. The system of claim 6 wherein the program further includes instructions for receiving services from the cloud service consolidator, wherein the services comprise at least a subset of the services provided by the cloud service.

8. The system of claim 6 wherein the program further includes instructions for forwarding additional user authentication factors to the cloud service consolidator along with the content.

9. The system of claim 6 wherein the mobile device further includes a secure element configured to secure at least a portion of memory within the memory unit.

10. The system of claim 9 wherein the program resides within the portion of memory secured by the secure element.

11. The system of claim 9 wherein the portion of memory secured by the secure element can be accessed only after authentication of a cloud service requesting access.

12. An apparatus configured to communicate with a mobile device, the apparatus comprising:
a secure element; and
a memory device outside the secure element, wherein at least a portion of the memory device can be accessed only after authorization by the secure element.

13. The apparatus of claim 12 wherein the secure element comprises a smartcard chip.

14. The apparatus of claim 12 wherein the apparatus comprises a microSD card.

15. The apparatus of claim 12 wherein the apparatus comprises a subscriber identity module (SIM) card.

16. The apparatus of claim 12 further comprising a universal serial bus (USB) connector to communicate with the mobile device.

17. The apparatus of claim 12 further comprising a contactless interface to communicate with the mobile device.

18. The apparatus of claim 12 further comprising a connector compatible with a dock connector on the mobile device.

19. The apparatus of claim 12 wherein authorization comprises authenticating a user.

20. The apparatus of claim 12 wherein authorization comprises authenticating an application to reside in the memory.

21. The apparatus of claim 20 wherein authorization comprises authenticating a cloud service to communicate with the application.

22. The apparatus of claim 12 wherein access after authorization results in one of adding, deleting, or modifying of data in the memory device.

23. The apparatus of claim 12 wherein access after authorization results in one of adding, deleting, or modifying an application in the memory device.
